(19) United States
(12) Patent Application Publication
(10) Pub. No.: US 2010/0103491 A1
(43) Pub. Date: Apr. 29, 2010

(54) METHOD FOR DETECTING POSITION OF REPRODUCED HOLOGRAM IMAGE AND HOLOGRAM APPARATUS

(75) Inventors: Michikazu Hashimoto, Higashimatsuyama (JP); Kiyoshi Tateishi, Hannou (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku (JP)

(21) Appl. No.: 12/531,787

(22) PCT Filed: Mar. 20, 2007
(86) PCT No.: PCT/JP2007/055759

§ 371 Date: Sep. 17, 2009

(51) Int. Cl. G03H 1/22

(52) U.S. Cl. 359/32

(57) ABSTRACT

A hologram reproduced image position detecting method used in a hologram apparatus which perfoming an image formation with light reproduced from a recording medium where a data page including a marker and a data area that have been displayed on a spatial light modulator is recorded, on an image sensor having a larger number of pixels than the spatial light modulator, thereby obtaining a reproduced image of the data page to reproduce the data page. The detecting method comprises the steps of storing a template image into which the marker has been interpolation-expanded, beforehand; oversampling the reproduced image of the data page in the image sensor to obtain a detected image; and performing a template matching process on the detected image using the template image, thereby detecting the position of the marker when recorded.

### TECHNICAL FIELD

The present invention relates to a hologram apparatus that records data as holograms or reproduces data from holograms and particularly to a hologram reproduced image position detecting method in the hologram apparatus.

### BACKGROUND ART

As memory systems, hologram memory systems are known which optically record or reproduce information into or from a hologram recording medium (hereinafter simply called a recording medium) made of photosensitive material such as photopolymer. For example, in the hologram apparatus, when recording, coherent light such as laser light is made to divide into signal light and reference light, and the signal light is intensity-modulated by a spatial light modulator according to input data. At the same time that the signal light is focused on a recording medium, the reference light is also irradiated into the recording medium to have the signal light and the reference light interfere, and resulting interference fringes are recorded as a pattern of change in refractive index or the like in the recording medium. When reproducing recorded page data from the recording medium, by making the same reference light as that in the recording incident at the same angle on the recording medium, diffracted light (reproduced light) corresponding to the interference fringes in the recording medium is reproduced, and this reproduced light is impinged on an image sensor having a larger number of pixels than the spatial light modulator to preform an image formation, thereby obtaining a reproduced image, which is demodulated through photoelectric conversion into a reproduced signal (detected image), thus obtaining output data.

In this hologram apparatus system, when recording data, the data is divided into image units called data pages that each are two-dimensional data, and the data page image is displayed on the spatial light modulator, thereby spatially modulating light into signal light.

In contrast, when reproducing, only the reference light under the same conditions as when recording is irradiated onto a data-recorded part of the recording medium, and hence an image sensor is used which has light receiving elements arranged two-dimensionally that correspond to the pixels of the spatial light modulator on the basis of one-to-one or an integer multiple ratio. The reproduced light is received by this sensor, that is, oversampled, and from the reproduced signal, information of an original data page is reproduced. In the hologram apparatus system, the oversampling generally means that one pixel of a reproduced image is received by a plurality of pixels of an image sensor to obtain a detected image, and the oversampling ratio refers to the ratio (one-dimensional ratio) of pixels of the image sensor to one pixel of a reproduced image. For example, if one pixel of a reproduced image is received by two pixel rows by two pixel columns of an image sensor, the oversampling ratio is two.

When recorded data is reconstructed from a data-recorded part of the recording medium, the quality of the data-page detected image is important. Accordingly, a predetermined fixed pattern called a positioning marker is contained in the data page and is displayed in the same shape and at the same place with its shape and location being constant. For example, the same specific symbol is contained at one or more places such as corners of the rectangular two-dimensional data. This marker is used to detect the position of the marker in signal reproduction, thereby identifying the position of the data page, correcting for the distortion of the data page, and so on thus enabling accurate decoding. Usually, when scanning a detected image, a specific frequency component ratio (marker reproduced signal) corresponding to a marker is obtained, and hence the center coordinates of each marker are determined from the marker reproduced signal, and since the entire shape of each marker is predetermined, the center positions of the pixels constituting each marker are obtained by calculation. Then, the positions of the pixels other than those of the markers, so-called data area pixels, can be obtained, with the pixels constituting the determined marker as reference pixels, by calculating from the coordinates of the reference pixels based on the width and height of the pixels. Because the positions of all data area pixels can be determined in this way, the data page of two-dimensional data can be detected by reading the data area pixels at those positions.

For example, in the hologram apparatus, based on the marker positions in the data page (detected image) read from the hologram recording medium, the amount of positional deviation between the center of the aperture area of the objective lens receiving light and the data page is obtained, and those positions are corrected such that the center of the data page coincides with the center of the aperture area of the objective lens (refer to Japanese Patent Application Laid-Open Publication No. 2005-227704).

However, when reproducing from a recording medium recorded by a hologram apparatus again sometime later, the position, etc., of a reproduced image on the image sensor may change because of the contraction/expansion of the recording medium due to temperature variation, or the contraction/expansion of the mechanism or the optical system of the apparatus due to temperature variation. Further, the position, etc., of a reproduced image may differ between a recording medium recorded by a hologram apparatus and a recording medium recorded by another hologram apparatus.

Even in the method (the oversampling ratio: 1) where the pixels of the data page (spatial light modulator) correspond to those of the image sensor on a one-to-one basis, one pixel of the spatial light modulator is not necessarily imaged on one pixel of the image sensor when reproducing data. Hence, reproduced light may be received by part between pixels of the image sensor, and thus the amount of light received per pixel is reduced. In this case, the reduction in the received light amount of the image sensor greatly affects the quality of the reproduced signal.

### DISCLOSURE OF THE INVENTION

### Task to be Solved by the Invention

In the conventional art, oversampling where a reproduced image is detected by an image sensor whose pixels correspond to those of the data page on the basis of an integer multiple ratio, not one-to-one, may be performed. For the integer multiple oversampling, the template image is an image that each of the pixels of the marker is simply duplicated to expand the marker into.

For example, in double oversampling, to take as an example a pattern used for position detection of a marker, each pixel of a black-and-white binary marker of 14 by 14 pixels shown in FIG. 1 (A) is simply duplicated to expand the marker into a black-and-white pattern of 28 by 28 pixels as shown in FIG. 1 (B).

Hence, in the conventional hologram apparatus, in the case where a data page is displayed on the pixels, e.g. 100 by 100 (=10,000) pixels, of the spatial light modulator to record it into a recording medium, the double oversampling requires an image sensor of 200 by 200 (=40,000) pixels in height and width. As such, an image sensor having an equal or greater number of pixels than the square of the number of pixels of the data page needs to be provided, and hence the number of pixels of the image sensor absolutely needs to be increased to increase sampling accuracy. An increase in the number of pixels of the image sensor increases production costs and prevents the realization of a higher detection rate of the image sensor.

Accordingly, a task to be solved by the present invention is to provide a hologram reproduced image position detecting method and a hologram apparatus which reduces the occurrence of data page reproduction errors and enables the realization of a higher detection rate of the image sensor.

### Means for Solving the Task

According to the present invention, there is provided a hologram reproduced image position detecting method used in a hologram apparatus which perfoming an image formation with light reproduced from a recording medium where a data page including a marker and a data area that have been displayed on a spatial light modulator is recorded, on an image sensor having a larger number of pixels than the spatial light modulator, thereby obtaining a reproduced image of the data page to reproduce the data page. The detecting method comprises the steps of storing a template image into which the marker has been interpolation-expanded, beforehand; oversampling the reproduced image of the data page in the image sensor to obtain a detected image; and performing a template matching process on the detected image using the template image, thereby detecting the position of the marker when recorded.

According to the present invention, there is provided a hologram apparatus which records interference fringes of signal light spatially modulated by a spatial light modulator and reference light into a recording medium, or which perfoming an image formation with light reproduced by the reference light from the recording medium where a data page including a marker and a data area that have been displayed on the spatial light modulator is recorded, on an image sensor having a larger number of pixels than the spatial light modulator, thereby obtaining a reproduced image of the data page to reproduce the data page. The hologram apparatus comprises a unit for storing a template image into which the marker has been interpolation-expanded, beforehand; a holding unit for movably holding the recording medium; an oversampling unit for oversampling the reproduced image of the data page in the image sensor to obtain a detected image; and a matching unit for performing a template matching process on the detected image using the template image, thereby detecting the position of the marker when recorded.

### BRIEF DESCRIPTION OF DRAWINGS

FIG. 1 is a conceptual plan diagram illustrating a marker and a template image for explaining conventional oversampling.

FIG. 2 is a schematic configuration diagram showing a hologram apparatus system of an embodiment according to the present invention.

FIG. 3 is a plan view showing schematically a data page displayed on a spatial light modulator in the hologram apparatus of the embodiment according to the present invention.

FIG. 4 is a flow chart showing the outline of the signal processing flow after receiving a reproduced image through data decoding in the reproducing operation of the hologram apparatus of the embodiment according to the present invention.

FIG. 5 is a conceptual plan diagram illustrating a marker and a template image of the embodiment according to the present invention.

FIG. 6 is a graph illustrating interpolation using a linear function of the embodiment according to the present invention.

FIG. 7 is a conceptual diagram illustrating a marker position detecting circuit for markers of an example according to the present invention.

FIG. 8 is a graph illustrating a relationship of a position detection error (RMS) against oversampling ratios of examples according to the present invention.

FIG. 9 is a conceptual plan diagram illustrating a marker and a template image of another example according to the present invention.

FIG. 10 is a conceptual diagram illustrating a marker position detecting circuit for markers of another example according to the present invention.

FIG. 11 is a conceptual plan diagram illustrating a template image of another example according to the present invention.

FIG. 12 is a conceptual plan diagram illustrating the pattern of a marker of another example according to the present invention.

FIG. 13 is a block diagram showing schematically the configuration of the signal processing system of a hologram apparatus of another example according to the present invention.

FIG. 14 is a flow chart showing conceptually the flow of a template matching process of another example according to the present invention.

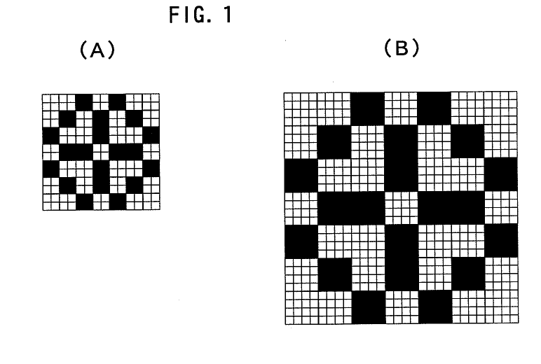

### EXPLANATION OF REFERENCE NUMERALS

10 Recording medium
20 Image sensor
21 Second lens

### 25 Encoder

### 26 Decoder

### 32 Controller

16 Objective lens
HM Half mirror
LD Light source

### SH Shutter

BX Beam expander
SLM Spatial light modulator

### DETAILED DESCRIPTION OF THE INVENTION

Embodiments of the present invention will be described below with reference to the drawings.

### <Hologram Apparatus>

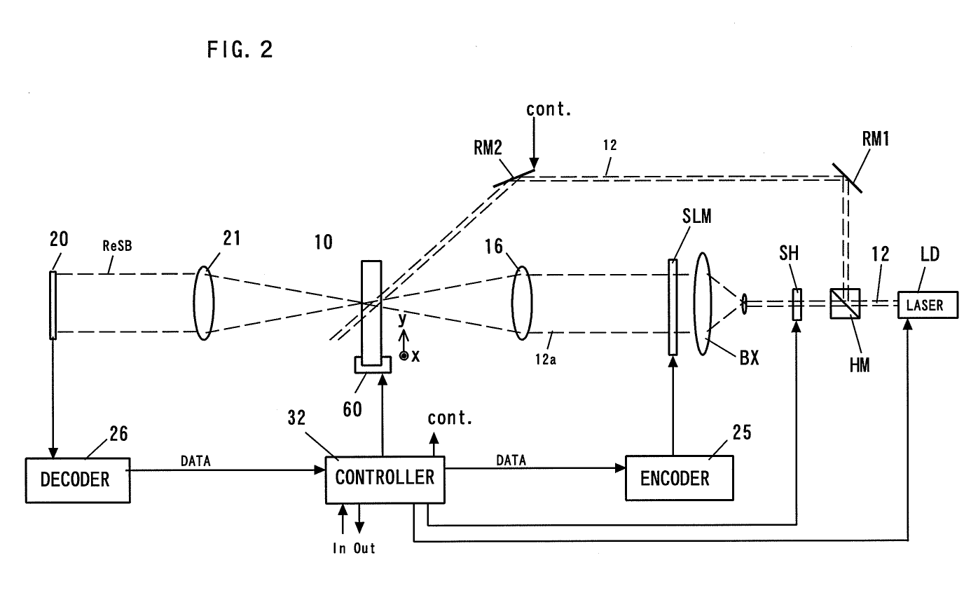

FIG. 2 shows an example of a hologram apparatus for recording and/or reproducing information.

In the optical path of coherent laser light 12 emitted from a laser source LD, there are arranged a half mirror HM, a shutter SH, a beam expander BX, a transmissive spatial light modulator SLM, an objective lens 16, a recording medium 10 made of photopolymer or the like, a second lens 21, and an image sensor 20.

The half mirror HM divides the laser light 12 into reference light and the other, and together with reflecting mirrors RM1, RM2 functions as a reference light optical system.

The shutter SH is controlled by a controller 32 to control time of the irradiation of a light beam onto the recording medium 10.

The beam expander BX expands light having passed through the shutter SH in diameter and collimates the light to be irradiated onto the spatial light modulator SLM.

The spatial light modulator SLM is a panel of a transmissive liquid crystal display (LCD) having multiple modulating pixels arranged two-dimensionally in a matrix. The spatial light modulator SLM has, for example, 480 rows by 640 columns of pixels and displays a data page from an encoder 25 to optically modulate the irradiated light into a spatial on/off signal, which is directed as signal light 12a to the objective lens 16. The encoder 25 is supplied with data (DATA) to be recorded and controlled by the controller 32.

When the shutter SH is open (when recording), the objective lens 16, Fourier transforming it, converges the signal light 12a to be focused behind the mounting position of the recording medium 10.

The recording medium 10 is mounted on a movable support 60.

The support 60 is controlled by the controller 32 to control the position of the recording medium 10 with respect to the optical axis of the objective lens 16.

The reflecting mirror RM2 of the reference light optical system irradiates the reference light 12 onto the recording medium 10 at a predetermined incident angle. The action of the reflecting mirrors RM2 causes the reference light 12 to intersect at a predetermined angle with the signal light 12a in the recording medium 10.

The intersecting signal light and reference light interfere with each other inside the recording medium 10. The interference fringes are recorded as a refractive index grating in the recording medium 10, and thereby the data page is recorded. By changing the intersection angle of the reference light relative to the signal light, a plurality of data pages can be recorded in an angle-multiplexing manner.

The image sensor 20 is constituted by an array of multiple light receiving elements arranged two-dimensionally such as CCDs (charge-coupled devices) or complementary metal-oxide semiconductor devices. Further, the image sensor 20 is connected to a decoder 26. The decoder 26 is connected to the controller 32. The light receiving elements of the image sensor 20 need not correspond to the pixels of the spatial light modulator on a one-to-one basis, but the sensor 20 need only have an arrangement of an enough number of light receiving elements to distinguish, especially, each pixel of an image of a data page displayed on the spatial light modulator.

When reproducing a recorded data page from the recording medium 10, with the signal light being blocked by the shutter SH, only the reference light is made incident at the same intersection angle as when recording. Reproduced light (diffracted light) corresponding to the recorded signal light appears on the opposite side of the recording medium 10 from the incidence side, on which the reference light is irradiated. The reproduced light ReSB is led to the image sensor 20 through the second lens 21. The image sensor 20 receives a reproduced image formed by the reproduced light and converts it into an electrical reproduced signal (detected image) again, which is then sent as data (DATA) via the decoder 26 to the controller 32, which reproduces original input data.

The controller 32 comprises a drive circuit for mechanically moving the support 60 and the like, a detected image memory for storing data from the image sensor 20, a position detecting circuit that has a template image memory for storing a template image and performs image processing, a distortion correction circuit, and a decoding circuit. That is, the controller 32 comprises a unit where a template image into which a marker has been interpolation-expanded is stored beforehand, a unit that holds a recording medium movably, an oversampling unit that oversamples a reproduced image of a data page in the image sensor to obtain a detected image, and a matching unit that performs template matching on the detected image using the template image to detect the position of the marker at the time of recording.

### <Data Page>

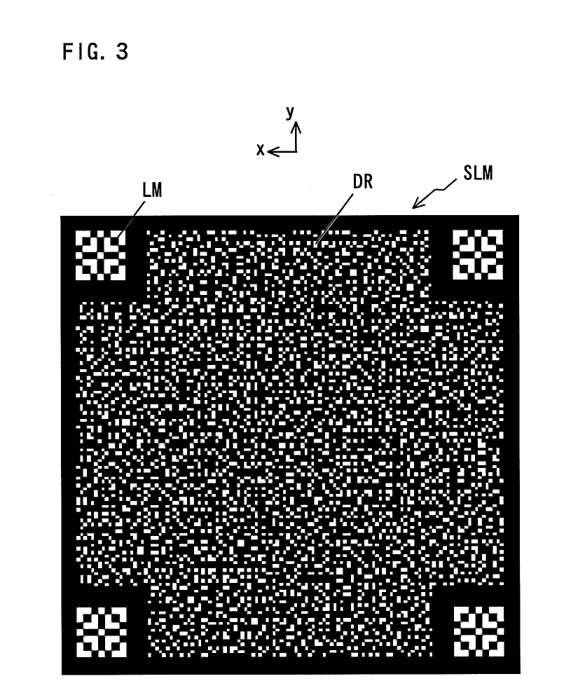

FIG. 3 shows a front view of the spatial light modulator SLM displaying the data page. A data page to be recorded into the recording medium is a black-and-white pattern image having a two-dimensional arrangement as shown in, e.g., FIG. 3. Markers LM are placed in the four corners of this data page. The marker LM is for enabling accurate decoding by detecting the position of the marker, when reproducing, to identify the position of a data area, correct for the distortion of the detected image, and so on.

The black-and-white dot pattern is displayed by ON and OFF voltage applied states of the cells and is a transparent and non-transparent pattern. In the spatial light modulator SLM, a group of two-dimensional modulated data pattern symbols of, e.g., 2:4 modulation or the like is displayed in a data area DR in the middle, with the markers LM displayed in, e.g., the four corners thereof. The 2:4 modulation is a scheme where input data to be recorded is divided into units of two bits and where each two bits are modulated into a two-dimensional modulation pattern symbol of four bits (2 by 2=4 pixels). The 2:4 modulation is an example, and not being limited to this, data may be recorded by another modulation scheme.

Because the position where a reproduced image is irradiated varies for the reason that the recording medium is moved to reproduce each page or so on, or for the adjustment of attachment position, the light receiving area (effective pixels) of the image sensor is usually designed to be somewhat larger than the area where the reproduced image is irradiated. Hence, the area where the detected image is irradiated needs to be identified in the output of the image sensor.

### <Reproducing Operation of the Hologram Apparatus>

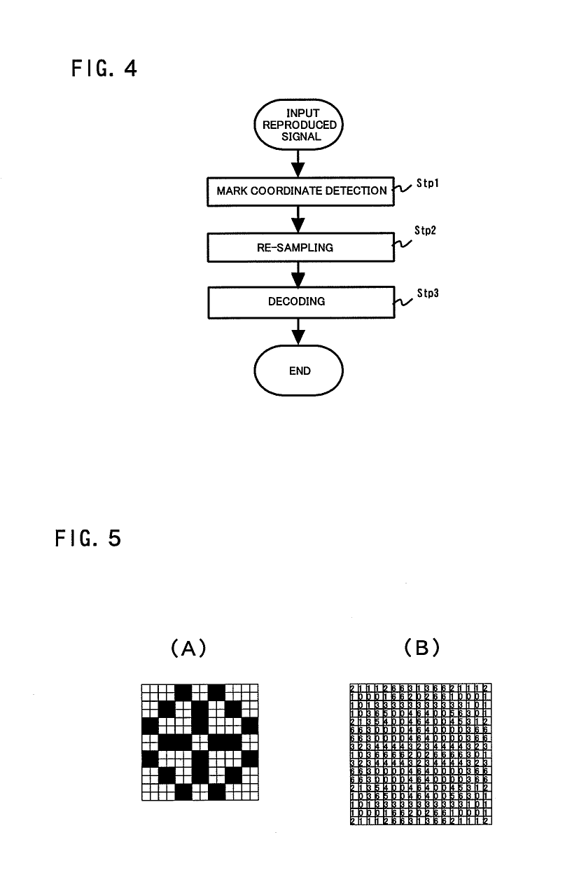

FIG. 4 shows the outline of the signal processing flow after receiving a reproduced image through data decoding in the reproducing operation of the hologram apparatus.

First, the coordinates of the four markers are detected in the detected image detected by the image sensor (marker coordinate detection: step Stp1). Then, the re-sampling of the reproduced image is performed (re-sampling: step Stp2). Then, data is decoded into (decoding: step Stp3).

### <Marker Coordinate Detection>

In the oversampling step, when the reproduced image is detected by the image sensor, mixed decimal multiple oversampling is performed so that the oversampling ratio is greater than one and less than two. For example, if an area of 3 pixel rows by 3 pixel columns in a reproduced image (the spatial light modulator) is received by 4 pixel rows by 4 pixel columns of the image sensor, the oversampling ratio is at 4/3. Oversampling of which the ratio is not an integer as such, is hereinafter called mixed decimal multiple oversampling.

Assuming that a spatial light modulator of, e.g., 100 by 100 (=10,000) pixels in height and width is used, in the present embodiment, because mixed decimal multiple, e.g. 1.2 times, oversampling is performed, an image sensor of 120 by 120 (=14,400) pixels in height and width, which are slightly greater in number than those of the spatial light modulator, needs to be provided. Hence, the number of pixels of the image sensor can be greatly reduced as compared with the integer multiple oversampling, thus reducing production costs. Further, with the reduction in the pixel numbers of the image sensor, the detection rate of the image sensor can be increased at relatively low cost, thus realizing a higher speed of data reproduction, which is preferable.

In the present embodiment, the mixed decimal multiple oversampling is used. The template image used for detecting the position of a marker cannot be the same in data as the marker. This is because the marker of the black-and-white binary cannot be simply expanded, as opposed to the integer multiple oversampling.

Thus, the steps of interpolation-expanding the marker and storing the interpolation-expanded template image beforehand are necessary.

For example, the pixels of a black-and-white binary marker of 14 by 14 pixels shown in FIG. 5 (A) are multiplied by 17/14 (about 1.2) so that the marker is expanded into a black-gray-white multi-valued (0 to 6) pattern of 17 by 17 pixels as shown in FIG. 5 (B) that is an interpolation-expanded template image, at substantially the same ratio as that of the mixed decimal multiple oversampling.

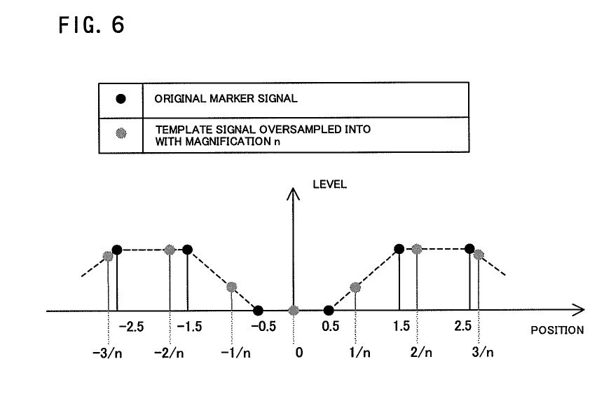

An example of the method of interpolation-expanding a binary marker into a multi-valued (grey level) template image is to interpolate using a linear function shown in FIG. 6. In FIG. 6, black dots denote an original marker signal, and grey dots denote a template signal into which the marker signal is interpolation-expanded with a magnification n. Let the pixel interval of the marker signal be 1. Then the pixel interval of the template signal is 1/n. With the center position of the original marker signal and the template signal as the origin of the coordinates, the coordinates of each pixel of the marker signal and the template signal are obtained. The value of each pixel of the template is obtained from its coordinates and a straight line joining marker pixel values before and after it. Note that interpolation using a quadratic function may be performed.

Then, the generated interpolation-expanded template image is stored in the template memory of the controller.

After a reproduced image of the data page is oversampled in the image sensor to obtain a detected image, template matching is performed on the detected image using the interpolation-expanded template image to detect the position of the marker at the time of recording.

The method of detecting the coordinates of a marker is to use a template matching process which searches for the position where the correlation value between the interpolation-expanded template image and the detected image is maximal. The template matching is one of general pattern matching methods and is known as a method which determines the degree of similarity or difference between a subject pattern and a standard pattern (template image) prepared beforehand to recognize the subject pattern. In the template matching, a correlation coefficient or a difference in light-and-shade level is often used as the degree of similarity or difference, and searching for correspondence between two images by an area correlation method, or so on is performed.

The correlation value Cxy between a reproduced marker image s(x, y) and a template image t(x, y) is expressed by the following equation (1), where (x, y) denotes coordinate positions:

$$Cxy = {\sum }_{x} {\sum }_{y} s ( x , y ) t ( x , y ) \qquad ( 1 )$$

Since detected coordinates are coordinates (integer coordinates) in pixel units, a further detailed decimal coordinate position can be obtained, for example, in one example of decimal coordinate position template matching described later. Also, the decimal coordinate position can be obtained by the method as disclosed in Japanese Patent Application Laid-Open Publication No. H10-124666.

### <Re-Sampling: Step Stp2>

Next, re-sampling is performed at equal intervals between the coordinates of detected four markers of the detected image so that the distance between the coordinates of the four markers contained in the data page becomes equal to the distance between the coordinates of markers of the detected image after re-sampling.

Assuming, for example, that the distance between the coordinates of the markers in the data page is 400 pixels and that the distance between the coordinates of the markers of the detected image is 405 pixels, the markers of the detected image are re-sampled at intervals of 405/400.

Through the re-sampling, the conversion of the sampling rate of the mixed decimal multiple oversampling and correction for distortion are performed. That is, through the re-sampling, the detected image becomes substantially the same as the data page.

### <Decoding: Step Stp3>

Next, a black-and-white pattern of the pixels of the data area DR is detected and decoded.

For example, the data area DR of the detected image is partitioned into regions the size of a two-dimensional modulation pattern such as the 2:4 modulation and so on to be image-processed, and correlations between the obtained signal and two-dimensional modulation patterns are calculated to detect the most similar modulation pattern, thereby decoding it.

### EXAMPLE 1

In Example 1, the pixels of a black-and-white binary marker of 14 by 14 pixels shown in FIG. 5 (A) are multiplied by 17/14 so that the marker is expanded into a black-gray-white multi-valued (0 to 6) pattern of 17 by 17 pixels as shown in FIG. 5 (B) that is an interpolation-expanded template image. When the interpolation process which interpolation-expands a binary marker into a multi-valued (grey level) template image is performed, since regions around markers in a data page are black as shown in FIG. 2, it is assumed that the outsides of the markers are black.

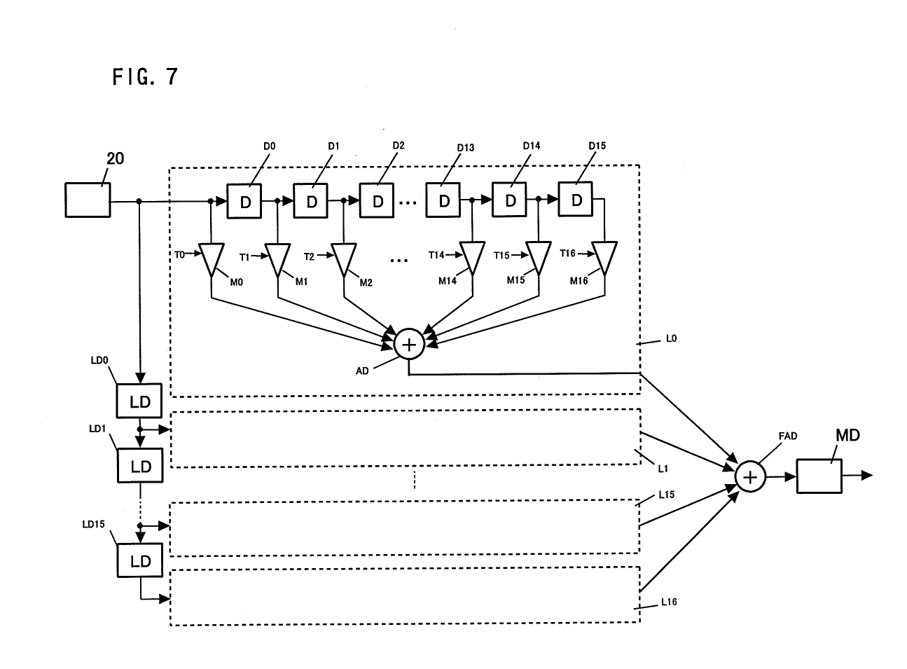

FIG. 7 shows the configuration of a marker position detecting circuit for the markers of Example 1. In this configuration, since the size of the template image is 17 by 17 pixels, the marker position detecting circuit may comprise, as shown in FIG. 7, row direction computing units L0 to L16 which each comprise delay units D0 to D15 connected serially in a row direction, multipliers M0 to M16 connected to the input or output terminals of the delay units, and an adder AD connected to the output terminals of the multipliers; one-row delay units LD0 to LD15 between the input terminals of the row direction computing units; and a final adder FAD connected to the output terminals of the row direction computing units. The delay units D0 to D15 are D flip-flops, and multiplier coefficients T0 to T16 of the multipliers each denote the value (one of multiple values) of a corresponding pixel of each row of the template image. The output of the final adder FAD provides the correlation value expressed by the equation (1). A maximum detector MD detects the maximum of the correlation value, for which the position of the detected image is the position of the marker.

In Example 1, because the template image is a multi-valued image, the multipliers as well as the delay units of the row direction and of the column direction and the adders are necessary. The multipliers being necessary is not preferable, because the circuit scale increases, but compared with the integer multiple oversampling, the number of delay units of the row direction and of the column direction can also be reduced as the pixel numbers of the image sensor receiving a reproduced image can be reduced.

Example 1 prepares individually a for-marker detected image memory for displaying images of marker on the spatial light modulator and a for-marker template image memory for storing the template image for detecting marker positions in a detected image detected by the image sensor, and is characterized in that the two are different in data contents from each other and that image data from the two are not similar to each other.

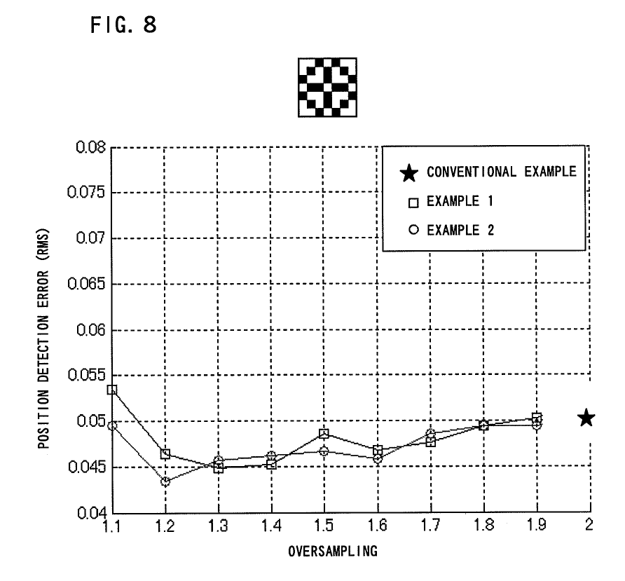

FIG. 8 shows that by the marker position detection of Example 1 using a multi-valued template image into which the marker has been interpolation-expanded, position can be detected with the same accuracy as by the marker position detection using the conventional integer multiple oversampling.

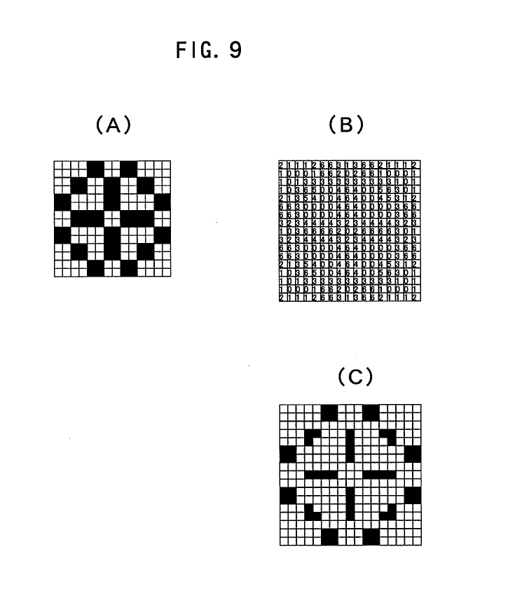

### EXAMPLE 2

Where the template image is multi-valued, correlation calculation performed in the marker position detection requires multiplication, thus increasing the circuit scale. Accordingly, a black-and-white binary marker of 14 by 14 pixels shown in FIG. 9 (A) is interpolation-expanded into a multi-valued (0 to 6) pattern as shown in FIG. 9 (B) with the same magnification as in the mixed decimal multiple oversampling of the image sensor, which is binarized with an appropriate threshold as shown in FIG. 9 (C), and the binarized pattern is used as a template image. As such, a binary image into which a multi-valued image into which the marker has been interpolation-expanded is binarized may be used as a template image.

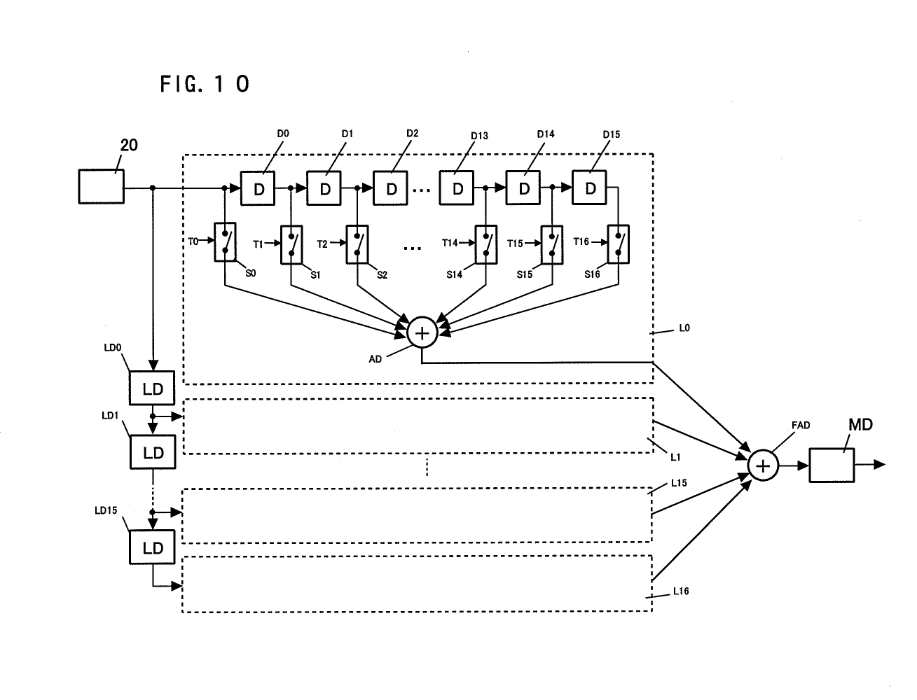

FIG. 10 shows the configuration of a marker position detecting circuit for this case. By binarizing, multipliers are unwarranted as compared with Example 1. Further, compared with the conventional art, the number of delay units can be reduced thus reducing the circuit scale, which is more preferable.

The marker position detecting circuit for markers may comprise, as shown in FIG. 10, row direction computing units L0 to L16 which each comprise delay units D0 to D15 connected serially in a row direction, switches S0 to S16 connected to the input or output terminals of the delay units, and an adder AD connected to the output terminals of the switches; one-row delay units LD0 to LD15 between the input terminals of the row direction computing units; and a final adder FAD connected to the output terminals of the row direction computing units. The delay units D0 to D15 are D flip-flops, and control signals T0 to T16 connected to the switches denote the pixels of each row of the template image, where when the value of Tn is at 1, the reproduced signal is added and when at 0, not added. More specifically, because the template image is fixed, the switches are fixed, and the value of each pixel of the template image determines the presence/non-presence of the line leading to the adder AD. The output of the final adder FAD provides the correlation value C expressed by the equation (1). A maximum detector MD detects the maximum of the correlation value, for which the position of the detected image is the position of the marker.

FIG. 8 shows that by the marker position detection of Example 2 using a template image into which the marker, after being interpolation-expanded to a multi-valued form, is binarized, position can be detected with the same accuracy as by the marker position detection using the conventional integer multiple oversampling.

### EXAMPLE 3

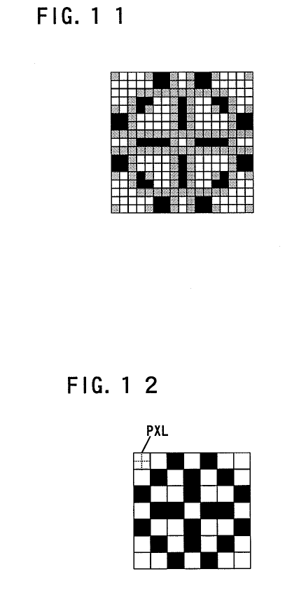

A second multi-valued image obtained by again converting a multi-valued image into which the marker has been interpolation-expanded to less multi-valued form may be used as a template image. For example, the multi-valued template image shown in FIG. 9 (B) may be ternarized with appropriate thresholds and used as a ternary template image as shown in FIG. 11. For example, if the template image is in ternary (−1, 0, +1), the correlation computation of the equation (1) can be performed with addition and subtraction, with the merit that multipliers are unwarranted.

Also in other variants where the template image is a second multi-valued image which is in quarternary (−2, −1, +1, +2) or quinary (−2, −1, 0, +1, +2), the computation can be performed with shift, addition, and subtraction, with the merit that multipliers are unwarranted.

It is not that any pattern is suitable as the pattern of the marker, but the selection is necessary. The minimum constituent unit of the marker needs to be a unit of 2 by 2 pixels (see PXL in FIG. 12).

Therefore, with any of the above examples, the pixel numbers of the image sensor and the number of delay units of the marker position detecting circuit are reduced with maintaining position detection accuracy, and thus a reduction in production costs and a higher speed of data reproduction can be realized.

### EXAMPLE 4

### <One Example of Decimal Coordinate Position Template Matching>

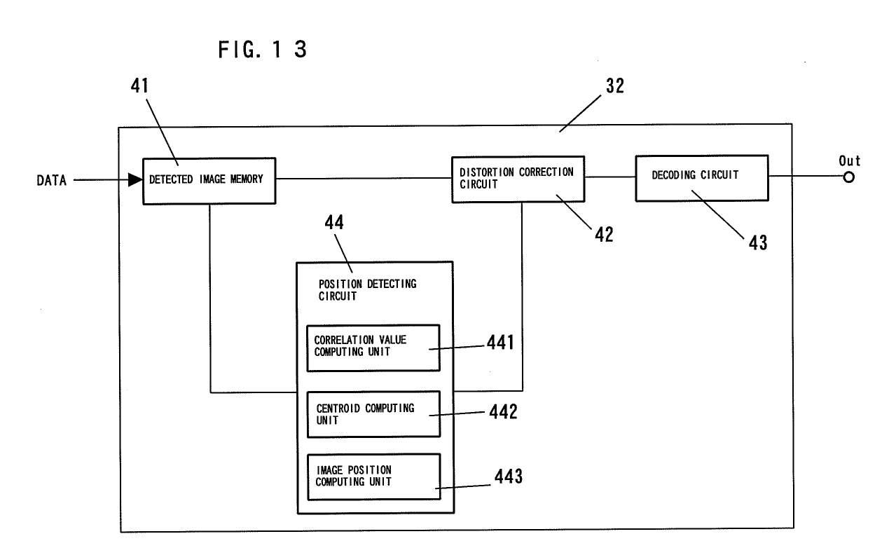

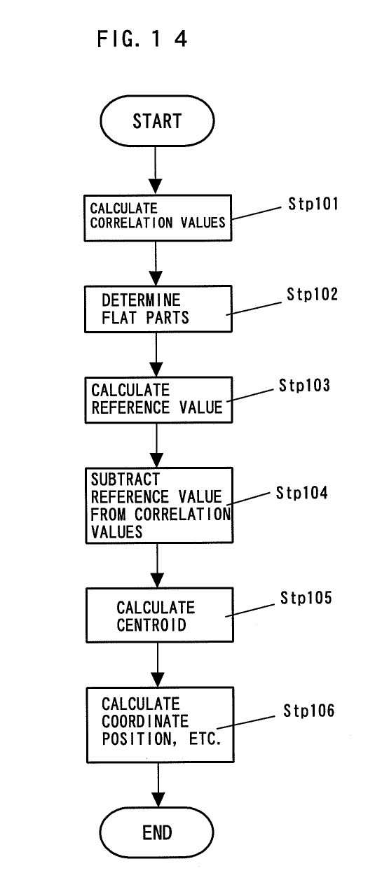

As shown in FIG. 13, the controller 32 of the hologram apparatus may comprise a detected image memory 41, a distortion correction circuit 42, a decoding circuit 43, and a position detecting circuit 44.

The detected image memory 41 temporarily stores output data (a detected image) output from the image sensor 20. The detected image memory 41 outputs the stored detected image pattern to the distortion correction circuit 42 and the position detecting circuit 44.

The distortion correction circuit 42 performs distortion correction on the detected image output from the detected image memory 41 based on the positional deviation amount of the detected image pattern output from the position detecting circuit 44 and thus identifies a data page.

At this time, the distortion correction circuit 42 performs, e.g., geometrical correction that is an example of the distortion correction. The geometrical correction means correction of deviation in pixel position between when recording data and when reproducing the data. An image pattern is transferred, when recording, from the spatial light modulator SLM to the recording medium 10 and, when reproducing, from the recording medium 10 to the image sensor 20 through an optical system. Because a difference in magnification and distortion in optical systems and the contraction of the recording medium occur between when recording and when reproducing, it is almost impossible to make pixel positions on the spatial light modulator SLM when recording completely coincide with pixel positions on the image sensor 20 when reproducing. Hence, for each page of the page data, the geometrical correction is performed. More specifically, the position of each pixel contained in the detected image pattern is corrected based on the deviation between the original marker position on the spatial light modulator SLM and the marker position detected in the reproduced image pattern that is calculated in the position detecting circuit 44.

In FIG. 13, the decoding circuit 43 demodulates the detected image pattern on which distortion correction has been performed in the distortion correction circuit 42 to output as reproduced data. The decoding circuit 43 performs data demodulation by, e.g., a demodulation scheme corresponding to a two-dimensional digital modulation scheme used in the spatial light modulator SLM when recording, and outputs reproduced data corresponding to the page data. Then, the post-process including error correction, de-interleave, de-scramble, and so on is performed on the reproduced data, and the resulting data is output as actual data.

The position detecting circuit 44 detects the coordinate position of the detected image pattern (or the positional deviation amount, distortion, and the like of the detected image) from the position of a marker contained in the detected image. This detection of the coordinate position and the like of the detected image pattern is performed by a template matching process described later.

The position detecting circuit 44 comprises a correlation value computing unit 441 constituting a specific example of “first computing means” of the present invention, a centroid computing unit 442 constituting a specific example of “second computing means” of the present invention, and an image position computing unit 443 constituting a specific example of “second computing means” of the present invention.

As shown in FIG. 14, first the correlation value computing unit 441 operates to calculate correlation values each indicating a correlation between the detected image pattern and the template image (that is, an image constituting the marker) (step Stp 101).

The detected image pattern is an image pattern corresponding to a data page displayed on the spatial light modulator SLM when recording. In contrast, the template image is an image pattern into which the marker used when recording is interpolation-expanded beforehand.

Correlation values between the detected image pattern and the template image are calculated, while the template image is moved on the detected image pattern pixel-unit by pixel-unit in X- and Y-directions. The greater the calculated correlation value is, the higher the possibility of the marker being added at that position is.

In FIG. 14, subsequently, the centroid computing unit 442 operates to determine the flat parts of the correlation values (step Stp 102). Specifically, the flat parts in the distribution of the correlation values are determined. The regions determined to be flat parts are called peripheral regions, and the other region than them is called a centroid region.

In FIG. 14, subsequently, the centroid computing unit 442 operates to calculate a reference value B of the multiple correlation values (step Stp 103). An example of the reference value B is the average of the correlation values in the peripheral regions.

Then, the centroid computing unit 442 operates to subtract the reference value B from each of the multiple correlation values in the centroid region and to set the subtracted correlation values as new correlation values (step Stp 104). That is, “Cmn-B”, where m=0, 1, 2, 3, 4 and n=0, 1, 2, 3, 4, are set as new “Cmn”. In addition, the multiple correlation values in the peripheral regions are set to zero. By clearing the values in the peripheral regions to zero, the number of computations shown below is reduced, thus increasing processing speed, which is preferable. Specifically, computations for the peripheral regions are omitted.

Thereafter, the image position computing unit 443 operates to calculate the centroid of the correlation values (step Stp 105). Specifically, the coordinate position Xc in the X-direction of the centroid (a relative coordinate position with respect to the coordinate position of the maximum of the correlation values calculated by actually moving the template image) is expressed by the equation (2), and the coordinate position Yc in the Y-direction of the centroid (a relative coordinate position with respect to the coordinate position of the maximum of the correlation values calculated by actually moving the template image) is expressed by the equation (3).

$$\begin{matrix}{X}_{c} = \frac{{\sum }_{m = o}^{4} {\sum }_{n = o}^{4} ( {C}_{mn} \times n )}{{\sum }_{m = o}^{4} {\sum }_{n = o}^{4} {C}_{mn}} - 2 & ( 2 ) \\ {Y}_{c} = \frac{{\sum }_{m = o}^{4} {\sum }_{n = o}^{4} ( {C}_{mn} \times m )}{{\sum }_{m = o}^{4} {\sum }_{n = o}^{4} {C}_{mn}} - 2 & ( 3 )\end{matrix}$$

Here, let the relative coordinates (Xc, Yc) of this centroid be decimal fraction coordinates. In contrast, let coordinates of the maximum of the multiple correlation values already identified be integer coordinates. Then the sum of the decimal fraction coordinates and the integer coordinates is obtained as absolute position coordinates. The absolute position coordinates are determined to be the detected position, in sub-pixel resolution, for which the correlation value is maximal. That is, it is determined that the marker is added at the position indicated by these coordinates in the detected image pattern, and thus the coordinate position, distortion, positional deviation, etc., of the detected image pattern can be calculated (step Stp 106).

### (Embodiment of a Decimal Coordinate Position Template Matching Processing Apparatus)

An embodiment of a decimal coordinate position template matching processing apparatus of Example 4 comprises first computing means that calculates correlation values each indicating a correlation between the input detected image and a predetermined template image in plurality on a pixel-unit basis, while displacing the template image relative to the detected image pixel-unit by pixel-unit; and second computing means that calculates the coordinate position of the detected image based on the coordinate position of the centroid (with the correlation values as weights) of the plurality of correlation values.

According to this embodiment, the first computing means operates to calculate correlation values between the input detected image and the predetermined template image. At this time, the correlation values are calculated while displacing the template image, a comparison subject, relative to the input detected image pixel-unit by pixel-unit. That is, a corresponding number of correlation values to the number of displacement times of the template image are calculated. If an image the same as, or like, the template image is included at a pixel position in the detected image, the correlation value at that pixel position is relatively large.

In contrast, if an image the same as, or like, the template image is not included at a pixel position in the detected image, the correlation value at that pixel position is relatively small.

In the present embodiment, the second computing means operates to calculate the coordinate position of the detected image based on the coordinate position of the centroid of the plurality of correlation values calculated by the first computing means. Specifically, the detected image and the template image have the highest correlation at the coordinate position of this centroid. That is, the position of the marker included in the detected image beforehand as, e.g., a positional reference of the detected image is determined based on the coordinate position of the centroid, and thus the coordinate position of the detected image is calculated. The coordinate position of the detected image may be calculated directly as, e.g., coordinates in a predetermined plane or a space, or indirectly as, e.g., a positional deviation amount of the detected image relative to a reference position.

In this case, the coordinate position of the centroid is calculated in sub-pixel units that are below a pixel unit that is the resolution in actually calculating correlation values. This is because the template matching processing apparatus according to this embodiment calculates the coordinate position of the detected image not using only the actually calculated correlation values but using the centroid of the correlation values obtained. In other words, that is because the coordinate position of the detected image is calculated using the centroid that can be located between correlation values calculated on a pixel-unit basis. By this means, the template matching processing apparatus according to the present embodiment can calculate the coordinate position of the detected image in sub-pixel units.

In addition, the centroid can be calculated by relatively simple computation (computation using, for example, correlation values calculated by the first computing means, pixel positions associated with the calculations of the correlation values, and the like). Hence, this embodiment also has an advantage that complex computation is not necessary. That is, this embodiment has two great advantages that the coordinate position of the detected image is calculated highly accurately and that the processing load necessary for it can be reduced.

In an aspect of the embodiment of a decimal coordinate position template matching processing apparatus of Example 4, the first computing means calculates correlation values while displacing the template image pixel-unit by pixel-unit in longitudinal and transverse directions two-dimensionally.

According to this aspect, the template image is displaced not in only one direction one-dimensionally but along the image plane of the detected image two-dimensionally. Thus, a two-dimensional distribution of multiple correlation values can be calculated. As a result, the centroid of the correlation values can be more accurately obtained. Thus, the coordinate position of the detected image can be calculated with higher accuracy.

In another aspect of the embodiment of the decimal coordinate position template matching processing apparatus of Example 4, the second computing means, after subtracting the minimum of a curved line or surface including a plurality of correlation values calculated by the first computing means from each of the plurality of correlation values, calculates the coordinate position of the detected image based on the coordinate position of the centroid of the plurality of subtracted correlation values.

According to this aspect, after the minimum of a curved line or surface including a plurality of correlation values (i.e., the minimum of the correlation values predicted from the distribution of the correlation values calculated by the first computing means) is subtracted from each of the plurality of correlation values, the centroid is obtained. This subtraction enables more accurate computation of the position where the correlation value is maximal by a relatively simple computation. As a result, the computed coordinate position of the detected image can be more highly accurate.

In yet another aspect of the embodiment of the decimal coordinate position template matching processing apparatus of Example 4, the second computing means, after subtracting the minimum of a plurality of correlation values calculated by the first computing means from each of the plurality of correlation values, calculates the coordinate position of the detected image based on the coordinate position of the centroid of the plurality of subtracted correlation values.

According to this aspect, after the actual minimum of a plurality of correlation values calculated by the first computing means is subtracted from each of the plurality of correlation values, the centroid is obtained. This subtraction enables more accurate computation of the position where the correlation value is maximal by a relatively simple computation. As a result, the computed coordinate position of the detected image can be more highly accurate.

In still another aspect of the embodiment of the decimal coordinate position template matching processing apparatus of Example 4, the second computing means, after subtracting the average of n number (n=an integer of two or greater) of relatively small ones of a plurality of correlation values calculated by the first computing means from each of the plurality of correlation values, calculates the coordinate position of the detected image based on the coordinate position of the centroid of the plurality of subtracted correlation values. This subtraction enables more accurate computation of the position where the correlation value is maximal by a relatively simple computation. As a result, the computed coordinate position of the detected image can be more highly accurate.

In another aspect of the embodiment of the decimal coordinate position template matching processing apparatus of Example 4, the second computing means calculates the coordinate position of the detected image based on each of the coordinate position corresponding to the maximum of the plurality of correlation values and the coordinate position of the centroid of the plurality of correlation values.

According to this aspect, the coordinate position of the detected image can be calculated with higher accuracy.

In another aspect of the embodiment of the decimal coordinate position template matching processing apparatus of Example 4, the first computing means calculates a plurality of correlation values on a pixel-unit basis, the pixel units being distributed in a matrix.

According to this aspect, a plurality of correlation values distributed in a matrix can be calculated. As a result, the centroid of the correlation values is more accurately obtained. Thus, the coordinate position of the detected image can be calculated with higher accuracy.

In the aspect of the decimal coordinate position template matching processing apparatus which calculates a plurality of correlation values on a pixel-unit basis, the pixel units being distributed in a matrix as described above, the apparatus may further comprise determining means that determines the relationship in magnitude between two correlation values, on opposite sides, adjacent in each of column and row directions to the maximum of the plurality of correlation values, and the second computing means may be configured, after subtracting the average of correlation values at the edge on the side, where the correlation value determined to be smaller by the determining means is located, of the plurality of correlation values for columns or rows of the pixel units distributed in a matrix from each of the plurality of correlation values, to calculate the coordinate position of the detected image based on the coordinate position of the centroid of the plurality of subtracted correlation values.

With this configuration, the determining means operates to determine the relationship in magnitude between correlation values, on opposite sides, adjacent to the maximum of the correlation values on a pixel-unit column or row basis. Based on the determination of the relationship in magnitude, the correlation value at the end on the side, where the smaller correlation value is located, is extracted on a pixel-unit column or row basis. For example, if one column consists of five pixel units and the correlation value associated with the third pixel unit is maximal, then the relationship in magnitude between the correlation values associated with the second and fourth pixel units is determined. If the correlation value associated with the fourth pixel unit is determined to be smaller than the correlation value associated with the second pixel unit, then the correlation value associated with the fifth pixel unit is extracted as the correlation value at the end.

As such, after subtracting the average of correlation values at the edge extracted on a pixel-unit column or row basis from each of the plurality of correlation values, the centroid is obtained. This subtraction enables more accurate computation of the position where the correlation value is maximal by a relatively simple computation. As a result, the computed coordinate position of the detected image can be more highly accurate.

In the aspect of the template matching processing apparatus comprising the determining means as described above, the first computing means may be configured to calculate a plurality of correlation values using a template image to have the distribution of correlation values at and near the edge be substantially flat.

With this configuration, correlation values at and near the edge are substantially the same, and thus correlation values at the edge can be regarded as the minimum of the plurality of correlation values. Hence, the computation of the centroid can be simpler, and thus the coordinate position of the detected image can be more easily calculated.

1. A hologram reproduced image position detecting method used in a hologram apparatus which perfoming an image formation with light reproduced from a recording medium where a data page including a marker and a data area that have been displayed on a spatial light modulator is recorded, on an image sensor having a larger number of pixels than said spatial light modulator, thereby obtaining a reproduced image of the data page to reproduce the data page, said detecting method comprising the steps of:
storing a template image into which said marker has been interpolation-expanded, beforehand;
oversampling the reproduced image of the data page in said image sensor to obtain a detected image; and
performing a template matching process on said detected image using said template image, thereby detecting the position of the marker when recorded.

2. A hologram reproduced image position detecting method according to claim 1, wherein an oversampling ratio in said oversampling step is greater than one and less than two.

3. A hologram reproduced image position detecting method according to claim 1, wherein said template image is a multi-valued image into which said marker is interpolation-expanded.

4. A hologram reproduced image position detecting method according to claim 1, wherein said template image is a binary image into which a multi-valued image into which said marker has been interpolation-expanded is binarized.

5. A hologram reproduced image position detecting method according to claim 1, wherein said template image is a second multi-valued image obtained by again converting a multi-valued image into which said marker has been interpolation-expanded to less multi-valued form.

6. A hologram apparatus which records interference fringes of signal light spatially modulated by a spatial light modulator and reference light into a recording medium, or which perfoming an image formation with light reproduced by the reference light from the recording medium where a data page including a marker and a data area that have been displayed on the spatial light modulator is recorded, on an image sensor having a larger number of pixels than said spatial light modulator, thereby obtaining a reproduced image of the data page to reproduce the data page, said hologram apparatus comprising:
a unit for storing a template image into which said marker has been interpolation-expanded, beforehand;
a holding unit for movably holding said recording medium;
an oversampling unit for oversampling the reproduced image of the data page in said image sensor to obtain a detected image; and
a matching unit for performing a template matching process on said detected image using said template image, thereby detecting the position of the marker when recorded.

7. A hologram apparatus according to claim 6, wherein an oversampling ratio in said oversampling unit is greater than one and less than two.

8. A hologram apparatus according to claim 6, wherein said template image is a multi-valued image into which said marker is interpolation-expanded.

9. A hologram apparatus according to claim 6, wherein said template image is a binary image into which a multi-valued image into which said marker has been interpolation-expanded is binarized.

10. A hologram apparatus according to claim 6, wherein said template image is a second multi-valued image obtained by again converting a multi-valued image into which said marker has been interpolation-expanded to less multi-valued form.

11. A hologram apparatus according to claim 6, wherein said matching unit comprises:
first computing means that calculates a plurality of correlation values each indicating a correlation between said detected image and a predetermined template image on a pixel-unit basis, while displacing said template image relative to said detected image pixel-unit by pixel-unit; and
second computing means that calculates the coordinate position of said detected image based on the coordinate position of a centroid of said plurality of correlation values.

12. A hologram apparatus according to claim 11, wherein said first computing means calculates said correlation values while displacing said template image pixel-unit by pixel-unit in longitudinal and transverse directions two-dimensionally.

13. A hologram apparatus according to claim 11, wherein said second computing means, after subtracting the minimum of a curved line or surface including a plurality of correlation values calculated by said first computing means from each of said plurality of correlation values, calculates the coordinate position of said detected image based on the coordinate position of the centroid of said plurality of subtracted correlation values.

14. A hologram apparatus according to claim 11, wherein said second computing means, after subtracting the minimum of a plurality of correlation values calculated by said first computing means from each of said plurality of correlation values, calculates the coordinate position of said detected image based on the coordinate position of the centroid of said plurality of subtracted correlation values.

15. A hologram apparatus according to claim 11, wherein said second computing means, after subtracting the average of n number, where n is an integer of two or greater, of relatively small ones of a plurality of correlation values calculated by said first computing means from each of said plurality of correlation values, calculates the coordinate position of said detected image based on the coordinate position of the centroid of said plurality of subtracted correlation values.

16. A hologram apparatus according to claim 11, wherein said second computing means calculates the coordinate position of said detected image based on each of the coordinate position corresponding to the maximum of said plurality of correlation values and the coordinate position of a centroid of said plurality of correlation values.

17. A hologram apparatus according to claim 11, wherein said first computing means calculates said plurality of correlation values on a pixel-unit basis for pixel units distributed in a matrix.

18. A hologram apparatus according to claim 17, further comprising:
determining means that determines a relationship in magnitude between two correlation values, on opposite sides, adjacent in each of column and row directions to the maximum of said plurality of correlation values,
wherein said second computing means, after subtracting the average of correlation values at the edge on the side, where the correlation value determined to be smaller by said determining means is located, of said plurality of correlation values for columns or rows of said pixel units distributed in a matrix from each of said plurality of correlation values, calculates the coordinate position of said detected image based on the coordinate position of the centroid of said plurality of subtracted correlation values.

19. A hologram apparatus according to claim 18, wherein said first computing means calculates said plurality of correlation values using said template image to have the distribution of correlation values at and near said edge be substantially flat.
